(19) United States
(12) Patent Application Publication
(10) Pub. No.: US 2022/0046091 A1
(43) Pub. Date: Feb. 10, 2022

(54) System and Method for Context-Aware Computing

(71) Applicant: 3G VISION PTY LTD, Erskineville (AU)

(72) Inventor: Emanuel DE SOUSA, Erskineville (AU)

(21) Appl. No.: 17/219,287

(22) Filed: Mar. 31, 2021

(30) Foreign Application Priority Data
Aug. 10, 2020 (AU) 2020902828
Sep. 14, 2020 (AU) 2020903288

(51) Int. Cl. H04L 29/08

(52) U.S. Cl. CPC H04L 67/1097

(57) ABSTRACT

The present invention provides an electronic system comprising a single unified data module (OneData), a single unified application module (OneApp), and an interprocess automation module (OneAuto).

### TECHNICAL FIELD

The invention relates to a system and/or method for Context-Aware Computing. More particularly, the present disclosure may relate to a system and/or method for an integrated context-aware computing application that comprises multiple utility applications.

### BACKGROUND

Current utility applications including word processing applications, spreadsheet applications, customer relationship management applications, calendar applications, accounting applications, typically rely on software application program interfaces to communicate with each other. The following are some attempts to provide a toolkit or method to allow multiple utility applications to communicate with one another.

One of the early attempts to provide data sharing between multiple utility applications was through the use of Object Linking & Embedding (OLE). Object Linking & Embedding (OLE) is a proprietary technology developed by Microsoft™ that allows for the embedding and linking to documents and other objects. For developers, this system brought OLE Control Extension (OCX) as a preferred way to use application program interface elements for communicating data between multiple utility applications.

Due to the limitation of OLE working on remote systems, Distributed Component Object Model (DCOM) was developed. Distributed Component Object Model (DCOM) is part of the proprietary Microsoft™ software toolkit for communication between software components running on networked computers. DCOM, which originally was called “Network OLE”, extends Microsoft's COM, and further provides the communication substrate under Microsoft's COM+ application server infrastructure to provide application program interfaces for different utility software.

Common Object Request Broker Architecture (CORBA) provides an open-source method that enables communications between software written in different languages and running on different computers. CORBA architecture uses an interface definition language (IDL) to specify the application program interfaces for objects present to the other utility software. CORBA then specifies a mapping from IDL to a specific implementation language like C++ or Java.

However, there are difficulties involved in adequately making DOOM or CORBA application program interfaces to work over Internet firewalls, and on unknown and unsecured computing machines, this generally meant that many software applications rely on using common gateway interfaces via the Internet and therefore generate limited the interoperability of different utility applications.

Oracle Fusion Middleware (FMW, also known as Fusion Middleware) comprises multiple software processes from Oracle Corporation. FMW spans multiple services, including Java EE and developer tools, integration services, business intelligence, collaboration, and content management. FMW depends on open standards such as BPEL, SOAP, XML, and JMS. Oracle Fusion Middleware provides software for the development, deployment, and management of service-oriented architecture (SOA) where multiple utility applications may involve API calls from the SOA.

Microsoft.NET “Framework” architecture is essentially a “Middleware” with typical middleware functions distributed between the various products, with most inter-computer interaction by open API's.

All the above methods of integrating multiple utility applications rely on basic Application Program Interfaces (API's) the building blocks. However, these API's of utility applications are not compatible or do not work well with other utility applications. The API approach creates an obstacle in the integration of multiple utility applications, creates storage, DB and application silos, and limits the development of cross application automation.

Any discussion of the prior art throughout this specification should in no way be considered as an admission that such prior art is widely known or forms part of the common general knowledge in the field.

### SUMMARY

### Problems to be Solved

It may be advantageous to provide for an embedded electronic device for running Context-Aware Computing.

It may be advantageous to provide for an application-specific integrated circuit for running an integrated context-aware application.

It may be advantageous to provide for a system or method for running Context-Aware Computing that has a plurality of utility software applications.

It may be advantageous to provide for a system and/or method for Context-Aware Computing that has a plurality of utility software applications.

It may be advantageous to provide for a system and/or method for Context-Aware Computing that generally includes a plurality of utility software applications able to share data and communicate with each other.

It may be advantageous to provide for a system and/or method for an integrated Context-Aware Computing application that has a plurality of utility software applications that maintains the context and entity information from other application datasets.

It may be advantageous to provide for a system and/or method for Context-Aware Computing that has a plurality of utility software applications that automates functions and processes of multiple utility applications.

It may be advantageous to provide for a system and/or method for an integrated context-aware application that has a plurality of utility software applications that minimise user errors.

It may be advantageous to provide a Context-Aware Computing that includes a plurality of utility software applications that automate workflow.

It may be advantageous to provide for Context-Aware Computing that includes a system for intelligent message routing.

It may be advantageous to provide for Context-Aware Computing that includes a system for managing multiple calendars on a single unified calendar.

It may be an object of the present invention to overcome or ameliorate at least one of the disadvantages of the prior art, or to provide a useful alternative.

### Means for Solving the Problem

In a first aspect of the present invention, there may be provided an electronic system comprising a single unified data module (OneData), a single unified application module (OneApp), and an interprocess automation module (OneAuto).

Preferably, the OneData module comprises: a single logical managed storage to allow access of all application files and document (OneStore); a unified logical database for all application data, template, and integration (OneDB); and a single data format where a common data format is used for all files and document types (OneFormat).

Preferably, the OneData module is adapted to store all application data, files and digitalised documents into a logical database by algorithms that maintain both the context and entity in a Unified Context Data Model (UCDM), for preserving the virtual linking of all associated entities and context.

Preferably, the Unified Context Data Model (UCDM) is adapted by using context entity resolution to identify different data fields (nodes) of each applications dataset and unidirectionally linking the different data fields together by digital references (links or pointers).

Preferably, the Unified Context Data Model (UCDM) is both Multi-App for managing data of all Apps, and Multi-Dimensional for providing a context-graph mind map view of the inter-relationship between all the associated entities and the contextual information architecture.

Preferably, the UCDM is adapted to deliver context-graph mind map (CGMM) which is a context-graph mind-map dataset for managing internally a large list of dynamic context-graph field information and the inter-relationship between associated items by algorithms.

Preferably, the OneData module comprises a set of application interfaces adapted to access each software application (app) data model, which enables all apps to access data from other apps.

Preferably, a single unified application (OneApp) comprising a set of functions (AppFunctions) and events (AppEvents) adapted to control and be controlled by other apps, processes, and the automation engine to form a plurality of utility software applications.

Preferably, the AppEvents are adapted to enable independent processes that may be triggered by application events which then execute AppFunctions.

Preferably, every time AppFunctions are called the OneData algorithm generates a context-graph mind map (CGMM) whereby all the parameters required by the AppFunctions are available in the CGMM, eliminating the need for AppFunction specific queries.

Preferably, OneAuto is adapted to provide four kinds of automation, comprising of user driven automation (assisted), process driven automation (unassisted), system automation, and cognitive automation.

Preferably, the user driven automation is a module comprising the user-driven automation AppFunctions, wherein the AppFunctions are triggered by a user input.

Preferably, the process driven automation is a module comprising the process driven AppFunctions.

Preferably, the system operates an automation (Autonomous) module comprising independent AppFunctions that are run by the system.

Preferably, the decision driven (Cognitive) automation is a module comprising the independently executed rules-based decision making AppEvents.

Preferably, user driven automation (Assisted), process driven automation (unassisted), system run automation (Autonomous), and decision driven automation (Cognitive) are all controlled by the OneSystem automation scheduling subsystem which provides a comprehensive set of automation features for user and process automation for the OneApp module and the OneData module.

Preferably, the electronic system further comprises an intelligent messaging system implementing the OneData, OneApp, and OneAuto modules and AppFunctions library, wherein the intelligent messaging system comprises, one or more intelligent message routers for intelligent message routing which routes messages to the most appropriate person; an intelligent categorisation module for automatically adding labels/tags to each message such that the messages are quickly identified; an intelligent parser that creates customer files, adds email information to the specific database fields in the OneDB, and automatically responds with dynamic contextual-data; an intelligent filing system for automatically filing of data, and a dynamic auto responder adapted to automatically respond with context-aware emails, faxes, SMS and printing letters.

Preferably, the intelligent message router is a content-based router based on an application-oriented network adapted to examine the content of the message for routing.

Preferably, the electronic system further comprises an integrated calendar application with the unified data model (OneData), unified application (OneApp), and interprocess automation (OneAuto) adapted to manage feature access with multiple calendar applications on one calendar interface.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 is the technology stack ‘of Context-Aware Computing of an embodiment of the present invention.

FIGS. 2a to 2d is a context-graph mind map which is used by the system of FIG. 1.

FIG. 3 is the context-aware application process of generating the context-graph mind map which is generated as an in-memory cache and used by the system of FIG. 1.

FIG. 4 is the context entity resolution process of fusing the context to the applications dataset of the UCDM and used by the system of FIG. 1.

FIG. 5 is a workflow diagram of a process executed in the integrated application of FIG. 1.

FIG. 6 is a workflow diagram of another process executed in the integrated application of FIG. 1.

FIG. 7 is a workflow diagram of, yet another process executed in the integrated application of FIG. 1.

### DESCRIPTION OF THE INVENTION

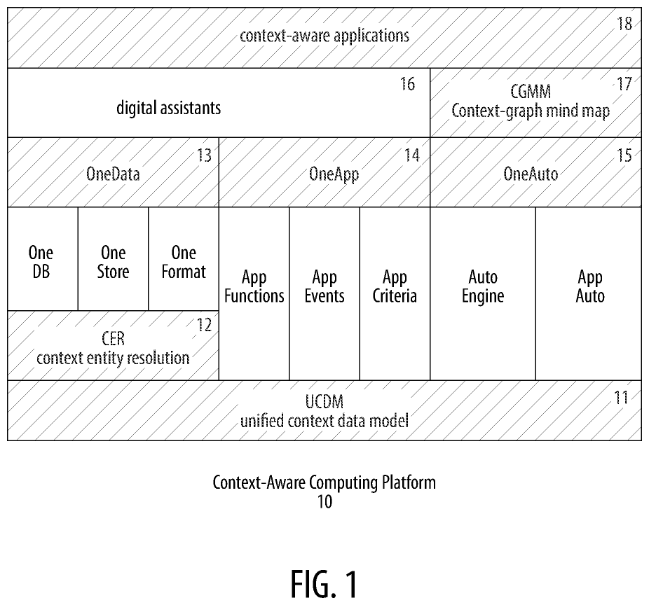

As shown in FIG. 1, there is provided the technology stack of an electronic system for Context-Aware Computing Platform 10 with a Unified Context Data Module (UCDM) 11, a context entity resolution module 12, a single unified data module (OneData) 13, a single unified application module (OneApp) 14, an interprocess automation module (OneAuto) 15, a context-graph mind map (CGMM) 17 and the context-aware apps 18. In one embodiment, the context-aware computing platform provides an application client to execute on a local computer system coordinating with a plurality of remote servers which are connected by a plurality of network devices. In another embodiment, the context-aware computing platform 10 is designed as an embedded system to be executed on a consumer electronic device.

There are seven fundamental technologies in the present invention that makes it unique and special over the prior art:
1. UCDM—the unified context data model of the present invention is a context based unified data model that accommodates the data set of all apps along with context an entity information.
2. CER—the context entity resolution (CER) module of the present invention extends the capability of every app by identifying the context and entity of all data and fusing the dataset of each app along with the context and entity to the unified context data model (UCDM) and enables every app to be Context-Aware.
3. OneData of the present invention makes all data instantly available to all apps, tasks and processes by managing all data to and from the Unified Context Data Model (UCDM).
4. OneApp of the present invention Enables apps to control and be controlled by other apps and processes with context-aware applications delivered as OneApp.
5. OneAuto of the present invention is made possible by unlocking the potential of Automation and enabling non-tech users to implement Assisted, Un-Assisted, Autonomous and Cognitive Automation tasks & processes.
6. CGMM—the context-graph mind map of the present invention produces an in-memory cache of all the context and entity information required by users, apps and the Automation Engine, eliminating the need for specific database queries.
7. Context-Aware Applications of the present invention refers to the apps ability to ‘see’ at the same level as a human, i.e., it has sufficient perception of the user's environment, situation, and context to reason properly. It identifies the current context and makes it available to all apps, tasks, processes and the automation engine.

Ultimately, the overall system UCDM (OneData UCDM) needs to accommodate the data model of each application and each application needs to comply with the OneData UCDM by becoming process and context-aware in order to maintain the UCDM inter-relationships with all the associated items.

The fundamental problem with API's is that the API's don't have OneData and OneApp, they are just a way to access information from other applications. The API's don't maintain the inter-entity and context relationship requirements of a structured data model such as OneData UCDM and don't offer the ability to execute a feature in another application such as OneApp.

This means that API's introduce today's biggest technical problems—they create application, storage, and database silos, and don't allow cross-application automation, which can only be solved with expensive RPA (Robotic Process Automation) systems and expensive customisation and integration engineering consultants.

OneData, OneApp, OneAuto and UCDM is a technical design methodology that overcomes the above technical barriers by providing a new design approach and implementation to the present computer system.

In one embodiment, the context-aware computing platform 10 of the present invention comprises an embedded system having a unified data (OneData) module, a unified application (OneApp) module, and an interprocess automation (OneAuto) module.

In one embodiment of the present invention, there is provided an context-aware computing platform 10 which integrates multiple storages, database and document silos into a unified data module (OneData) having a single managed storage to allow access of all application files and document (OneStore), a unified logical database for all application data, template, and integration (OneDB), and a single data format where a common data format is used for all files and document types (OneFormat).

In the single unified data module (OneData) of the present invention, the fusing of each applications data-set is managed by algorithms that use context entity resolution to maintain a Unified Context Data Model (UCDM), whilst preserving the virtual entity and contextual linking of users, clients, services, invoices, appointments . . . etc (of all associated entities). The Unified Context Data Model (UCDM) is adapted to identify different contextual data (nodes) unidirectionally linked together by digital entity references (links or pointers).

A potentially important element of OneData is the Unified Context Data Model (UCDM), which is both a Multi-App and Multi-Dimensional subsystem, wherein the Multi-App subsystem manages the data of all Apps, and wherein Multi-Dimensional subsystem provides a context-graph mind map dataset of the interrelationship between all the associated entity and contextual items.

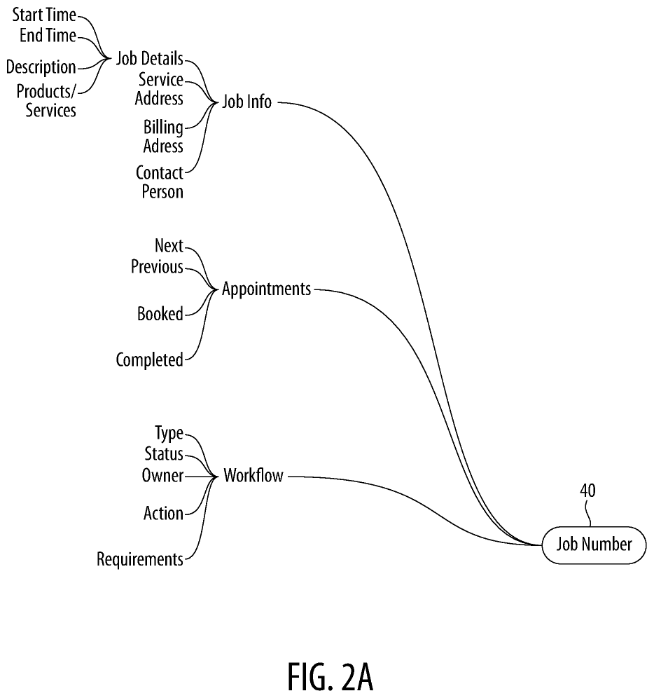

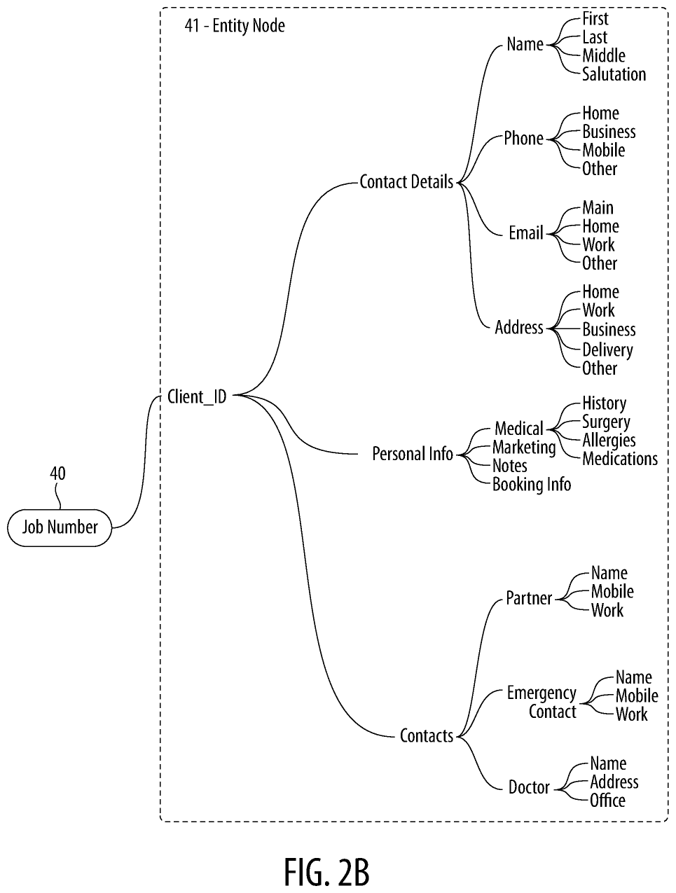

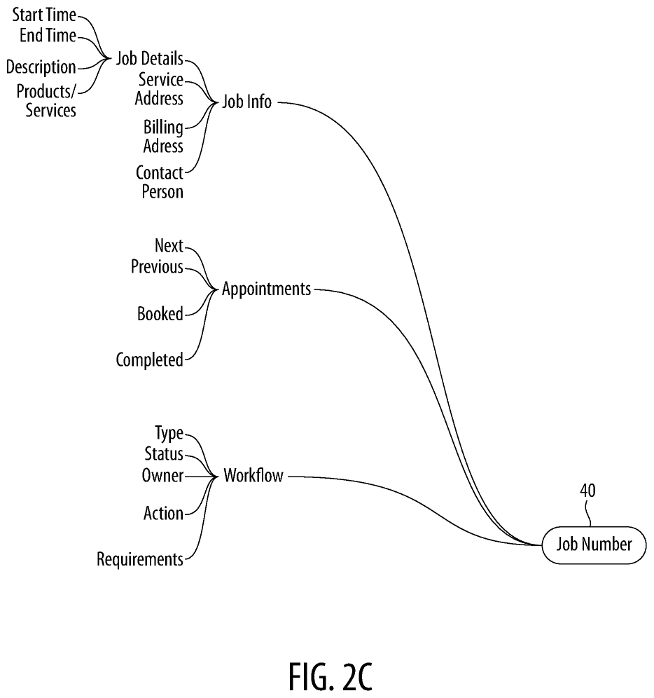

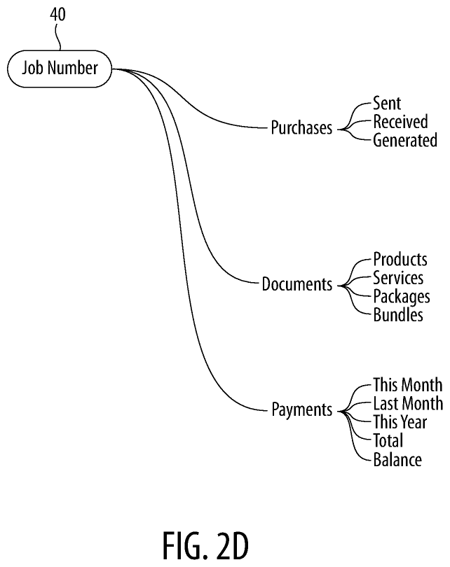

The unique UCDM was also designed to deliver the Context-Graph Mind Map (CGMM) which is a context-based dataset structure, that dynamically provides all the required information to all apps and processes without the need for bespoke complex database queries. (as illustrated in FIG. 2a-2d) The CGMM allows for a large list of context-based information and the inter-relationship between associated entity and contextual items, such as Invoices, Jobs, Appointments, Messages, etc. The CGMM is internally managed by the OneData algorithms which generate an in-memory cache making all relevant data instantly available to apps and processes and may hold tens of thousands of data fields which are specific to an entity and its associated contextual relational items. It is through Algorithms such as OneData, CGMM, OneStore, OneDB, and OneFormat that makes it possible for all Applications and Integrations to access All Data from the entire system and its applications.

Referring to FIG. 2, One of the most important components required by OneData is the context-graph mind map (CGMM), which is a dynamically cached context-graph dictionary, designed as a key-value-pair (KVP), where we store two linked data items; the key, used by all applications and processes; and the value, derived from the UCDM. The CGMM is generated and cached upon many events throughout the system and eliminates the need for custom specific database queries, thus greatly simplifying the use, design, and automation. When a context-aware app passes the context e.g., Job number as per FIG. 2—Node 40 it then generates the various Nodes of the CGMM. The main Nodes generated are the Entity Node 41 and the other associated context Nodes like Node 42, Node 43 and 44. It is important to note that the entire CGMM as per FIG. 2 can be generated with only a single context nodes such as either nodes 40, 42, 43 or 44. As the context-graph is derived from the UCDM thus it can build the context-graph in a Graph Mind Map Structure, which is why we call it the context-graph mind map (CGMM).

All Apps and integrations store data in one database (OneDB) in a Unified Context Data Model (UCDM). The unified data comprises a set of application interfaces adapted to access each software application (app) data model. This enables all apps to access data from other apps.

General software applications do not have access to other App data Models. Hence, preventing different software applications to share data and allow functional connectivity amongst them. All digitised data types have access to a common data model meaning all data can be made available in all different data formats. Without the Unified Context Data Model, data is stored based on the original software applications. As such, this may pose a risk to cause memory overrun or system error when reading and manipulating by another software application.

For example, Microsoft™ Outlook application is incapable of doing this due to poor limited data model and no unified hierarchical structure. A Microsoft Outlook appointment is only aware of meeting attendees and has no other linking. An embodiment of the present invention system is adapted to link the appointment to a client (Entity Linking) and then to a job or a service (Context Linking), which can contain various items and products that belong to stock management which belongs to an invoice (Sub-Context Linking).

The main differences between the prior art and the current invention is that the current invention applies the UCDM to all software applications and integrations when working with and saving information and applies the CGMM to all applications and integrations. No other system does this as they are unaware of the efficiency, security, and flexibility of such system using the current OneData architecture.

The current invention comprises an OneData architecture that includes: One Store software module, One Database software module, and One Format software module. The One Store software module is adapted to provide a unified managed storage and access for the electronic files and digitalised data for all different software applications. The One Database software module is adapted to keep and manage all application data, templates, and data integration in one Unified database. The One Format software module is adapted to maintain the atomicity of data transactions with multiple software applications simultaneously.

In an embodiment of the present invention, the electronic system of an context-aware computing platform 10 which provides a single unified application (OneApp) comprising a plurality of utility software applications, such as word editors, spreadsheet, presentation, image editing, calendar, email, etc, to interact control, and be controlled, with one another. OneApp comprises a set of library AppFunctions and AppEvents that enables apps to control and be controlled by other apps, processes, and the automation engine.

In order to make OneApp possible, the present invention enables every application to be context-aware and comprises a library of AppFunctions, all Applications have been broken down into their basic feature set and developed as a list of feature functions (AppFunctions) that can be used throughout the system by other apps, processes, and the automation engines. The AppFunctions may be called and executed from any process or any app and retrieve all required parameter information from the context-graph mind map (as illustrated in FIG. 2a-2d).

This generally enables the system to include the additional ability to execute cross-application features from any app. To support system and process automation functions, the context-aware computing platform 10 of the present invention comprises a library of application events (AppEvents) which enables independent processes to be triggered by application events which then could execute AppFunctions.

The OneApp algorithm enables each app to be context-aware and comprises a comprehensive library of functions and events that enable applications to control and be controlled by other apps, processes, and automation engines. A comprehensive list of other app features is available within each app that enables the app to control other Apps.

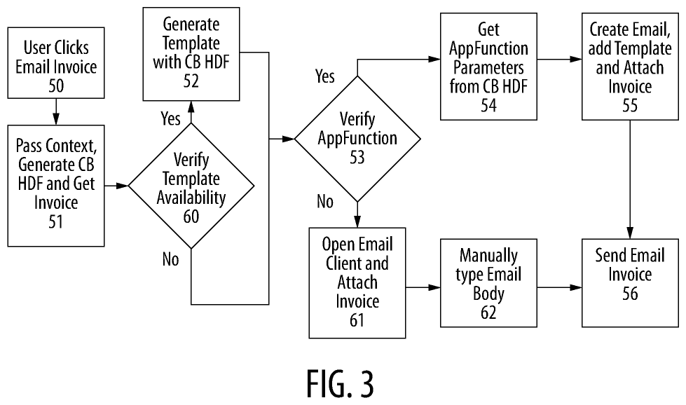

Referring to FIG. 3, all applications are context-aware and thus in Step 50 when a user clicks Email Invoice, the OneApp Algorithm passes the context (Invoice no.) and the AppEvent (Email_Invoice) to the OneData algorithm which in turn generates the context-graph mind map (as illustrated in FIG. 2a-2d) and creates the invoice pdf as per Step 51. At Step 60 the OneApp Algorithms verify if there is a template for the Email Invoice AppEvent. At Step 52, the context-aware template which contains both static and dynamic data, uses the KEY of the key value pairs of the CGMM data to automatically place the values in the template. At Stage 53 the AppFunction Send_Email is called and at Stage 54 all the parameters required by AppFunction are retrieved from the CGMM. The Email is created with template info, the invoice is attached as per Step 55 and then Sent as per Step 56. Step 60, if there is no template, Step 53 opens a blank email client, adds the invoice attachment as per step 61. Then at Stage 62 the user manually types out the email and then presses Send.

In one embodiment, the single application (OneApp) may control and coordinate thirty-three (33) or more utility software applications, such as Office like Apps with OneData delivered as OneApp. In a further embodiment, the AppFunction comprises a light-weight segment of software code, such as byte code or binary code, which is capable of being executed as an individual thread on an electronic device. Preferably, the AppFunction will enforce strict type binding to the OneData in order to maintain interoperability. Also, the AppFunction is preferably compiled or interpreted into intermediate code such that it is compiled or interpreted into machine codes to be executed in different electronic devices.

The single integrated context-aware application may have a comprehensive list of user processes, and system-based events (AppEvents) that can trigger and be triggered by AppFunctions.

The true value of an embodiment of the present electronic system having OneData and OneApp becomes apparent when the apps adapt to the changing context of a user in order to serve-up all the situation specific information required by a user to complete each task or when it is implemented in a unified automation process OneAuto whereby the tasks are completed automatically.

OneAuto is adapted to provide four kinds of automation including: user driven automation, process driven automation, system run automation, and decision driven (cognitive) automation. These four types of automations are organised into two by two layers of automations—two layers with 2 levels of automations on each layer.

In one embodiment, the user driven automation is a module which comprises user-driven automation AppFunctions that are triggered by context-based user inputs, such as one-click automation to streamline the interactions with emails, fax, SMS, appointments, notes, spreadsheets, letters, quotes, and invoices and the like. Upon receiving a message, such as an email, fax, SMS, etc, the user automation is adapted to generate context-based documents, work orders, and other kinds of print documents with a single click AppEvent.

In one embodiment, the process driven automation is a module comprising the process driven AppFunctions, such as workflow automation of all business processes, multiple action executions, automation documents tracking, SMS confirmation, and mass SMS and emails generation and distributions.

In one embodiment, the system run automation is a module comprising of the independent AppFunctions run by the system, such as client data updating, job completion, payment processing, message routing, message tagging, calendar syncing, automatic filing & attach: emails, docs, faxes, SMS, voicemails, images, and generating scheduled reports.

In one embodiment, the decision driven (cognitive) automation is a module comprising the independently executed and independent decisions making AppFunctions, such as autopilot system and client follow-ups, fully automated SMS confirmations, natural language parsers for creating files and auto-replies, VMS, images, digital documents, invoices, payments, and rego forms.

These automations—user driven automation (Assisted), process driven automation (unassisted), system run automation (Autonomous), and decision driven automation (Cognitive) are all controlled by OneSystem automation scheduling subsystem. The main app automation (AppAuto) with OneApp and OneData enabling a comprehensive set of automation features for user and process automation.

In the first layer, the AppAuto is used by the main apps and was designed for the graphical user interface (GUI) based foreground user and process automation with OneApp and OneData capabilities. In the second layer, there is provided an automatic processes management engine (AutoEngine) that is responsible for background apps, daemons, and multithreading automation for autonomous and cognitive automation processes. The AutoEngine is an independent automation engine with OneApp and OneData enabling innovative autonomous and cognitive features.

Both automation engines are interoperable and are adapted to hand over work to the most appropriate engine for each automation function. Dual interoperable automation systems designed as a single system, with OneData and OneApp that enables the simple automation of thousands of features via user, process, autonomous and cognitive automation.

In different of the present invention compared to the prior art is that the prior art system is designed around Application Programming Interfaces (API's), Robotic Process Automation (RPA) and Digital Transformation which is less effective and efficient than building and designing an electronic system around OneData and OneApp which lead to OneAuto.

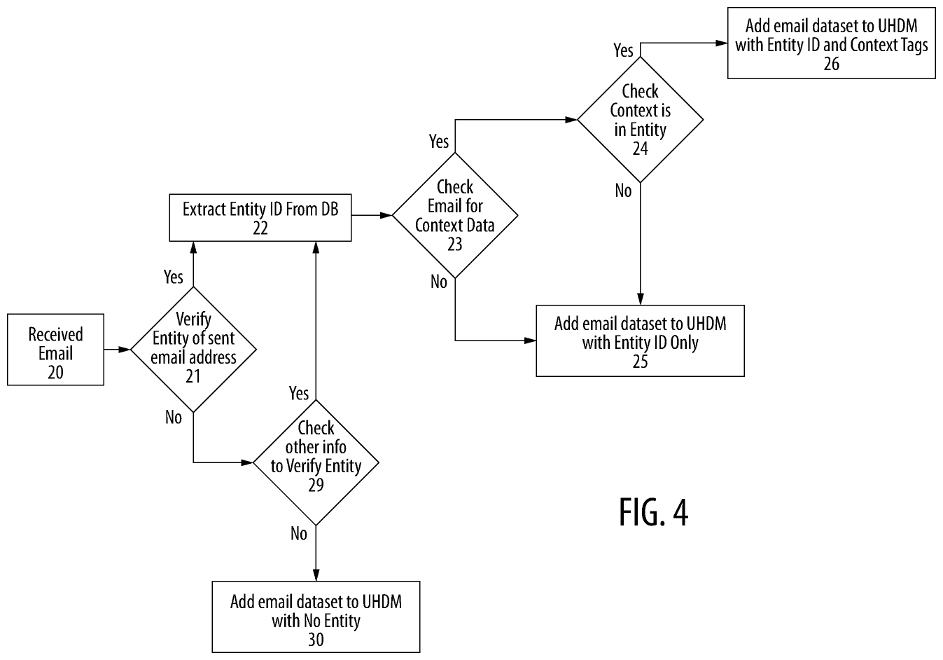

Referring to FIG. 4, all emails which are received by the system as in Step 20, are first required to verify the entity of the email as in Step 21. If the entity can be found in the database Step 22, an attempt is made to locate available contextual data Step 23, if contextual data is found then a check is made against that entity Step 24 and finally the email dataset is fused to an existing entity with contextual data in the UCDM as in Step 26. If at Step 21 there is no entity match by using the email address a further entity check is done by looking at a combination of Mobile Numbers, First Name and Surname an other fields that can produce a reliable entity match as at Step 29. If No entity match can be made the email is placed in the main messaging screen whereby the user is provided with tools to manually attach that email to the appropriate entity whereby then the system attempts contextual analysis and linking if available. At Step 23 if no further contextual data is found the email data set is added to the UCDM with the available entity and main context linkage. During Step 20 the OneData algorithms download and analyse the email and determine whether it meets one of the AppEvent rules, wherein if one of the AppEvent rules are met, the automation engine processes the email according to those rules described below.

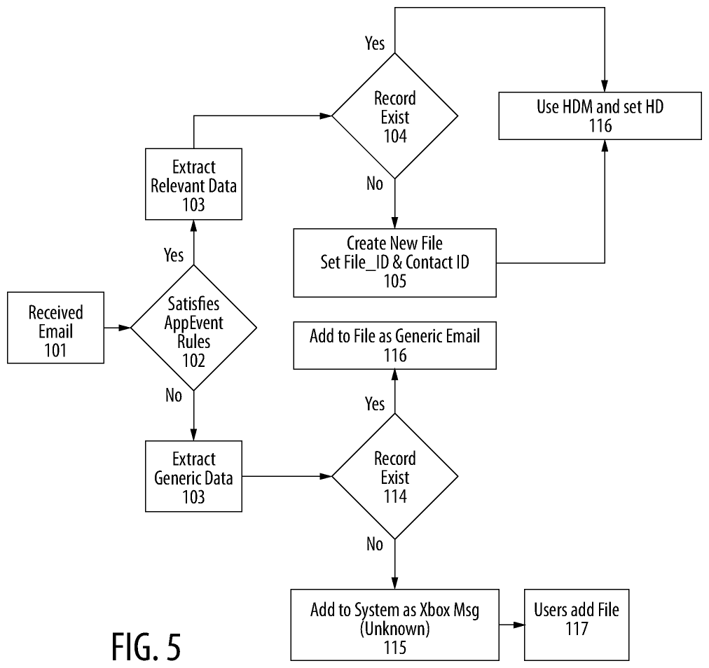

Referring to FIG. 5, the OneAuto module passes the emails through a rules processor circuit (autonomous Automation) in the electronic system of the present invention as in Step 101. In one embodiment, a new client email is generated from a company's web form that requires customers to input the First Name, Surname, Phone Number, Email Address, and message., etc. The browser may encrypt the data and passes to the system of the present invention through a common gateway interface.

When the context-aware computing platform 10 of the present invention receives a new email, it first checks if the email satisfies any of AppEvent rules as in Step 102, if so, it extracts all the relevant data (as per the rule) as in Step 103, it then does an entity lookup, for example, the phone and email as in Step 104.

If an existing record is not found in (No entity match) Step 104, the context-aware computing platform 10 automatically creates a new client file (new entity) in Step 105. The electronic system then uses the UCDM to set the appropriate CGMM context fields such as Action_ID, Message_ID, Appointment_ID, Invoice_ID, Job_ID, CaseOwner_ID, Document_ID as in Step 106, that is relevant to the email rule.

If an existing record is found (Entity match) in Step 104, the context-aware computing platform 10 uses the UCDM and sets Contact ID (Entity) and then sets the Action_ID, Message_ID, Appointment_ID, Invoice_ID, Job_ID, CaseOwner_ID, Document_ID, (which are the contextual Links) that are relevant to the AppEvent rule as in Step 106.

The AppEvent new email rule process can be plain emails, emails with documents, booking emails, job completion emails, etc. All of these are editable and can be customised to almost any requirement.

By defining a set of rules (autonomous automation rules) that make up the OneData Algorithms, the context-aware application of the present invention is adapted to ensure that all emails received are context and entity tagged and processed appropriately.

The above example uses the OneData UCDM and context-graph mind map to attach the email to the correct file. If the file does not exist, it also creates a new file and most importantly it updates the CGMM so that all other applications can access the received email and the updated information in Step 107.

In Step 102, the integrated application checks if the email satisfies any of the AppEvent rules. In the event that the email does not satisfy any of the AppEvent, the context-aware computing platform 10 extracts all the generic data as in Step 113. It then does a lookup, for example, the phone and email (Entity Lookup) as in Step 114.

If an existing record is not found in Step 114, the context-aware computing platform 10 automatically adds the email to the OneData module as Xbox Message (New Un-known Entity) in Step 115. The user may then add the email to the file of the OneData module (User based entity matching) in Step 117. If an existing record is found (Entity Resolution Update) in Step 104, the context-aware computing platform 10 will add the email to a file of the OneData module as a generic email in Step 116.

In another example as shown in FIG. 5, the context-aware computing platform 10 of the present invention is adapted to execute a process that was manually triggered by a status change in the process. In this case, the process state was changed by a human thus this would be classified as an unassisted Automation which is made possible with OneApp.

As all processes and utility applications in the Context-Aware Computing Platform 10 use the UCDM and CGMM to look up and tag everything, the OneData module can get the context from the top levels of the CGMM to initiate tasks and processes with the AppEvent, traditionally this is only possible with heavily integrated RPA Systems.

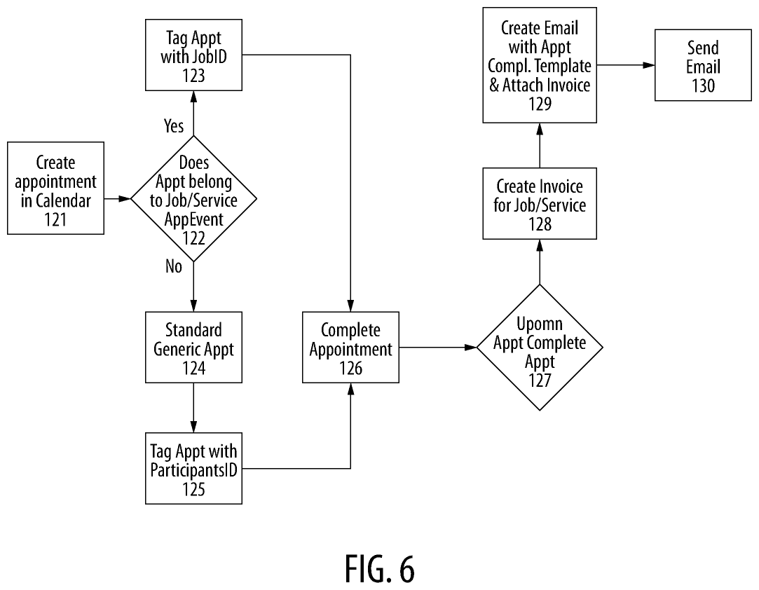

For example, referring to FIG. 6, when a user creates an appointment for a job/service in the calendar in Step 121, the context-aware computing platform 10 will determine whether the appointment belongs to Job/Service (Context Resolution) AppEvent in Step 122. The UCDM will tag the appointment with the job/service (Contextual info) ID in Step 123 if the appointment belongs to Job/Service AppEvent in Step 122. Otherwise, the context-aware computing platform 10 will create a standard generic appointment record (Entity Only) in Step 124 and then tag the appointment with ParticipantsID in Step 125. This process will ensure that with the Appointment_ID, OneData module via the CGMM can provide access to all the job info such as client info, job description, amount, invoice, paid status, etc.

Thus, upon the AppEvent appointment recording completed in Step 126, the AppEvent can in Step 127:
Access the invoice information (CGMM) in Step 128;
Generate invoice (OneApp) in Step 128;
Create an email and Attach Invoice (OneApp) in Step 129;
Add context-aware Email Template (Email Body, Subject plus To, CC and BCC addresses) (CGMM) in Step 129;
Send Email (OneApp) in Step 130.

In another embodiment, the context-aware computing platform 10 is adapted to execute a process that was triggered by a client purchase event. In this case, the purchase meets the AppEvent which places the client of the purchase in a campaign list of the OneData to be processed by the AutoEngine, as there are various rules this is classified as Rules Based Cognitive Automation.

In one embodiment of the present invention, the OneAuto was designed to facilitate the 4 levels of Automation: Assisted, Unassisted, Autonomous, and Cognitive Automation. These 4 Levels of automation are divided into two subsystems:
OneAuto—Front end automation that runs in the main applications for assisted and unassisted process automation
AutoEngine—Background automation which runs 24×7 as an independent automation engine which is designed for autonomous and cognitive automation.

To make OneAuto possible, the following applications and algorithms are required:
Context-Aware Template
OneData
OneApp
AppEvents
AppEvent Criteria

These applications and algorithms make it possible for the automation engine to access all required data, trigger upon specific events, and execute features that belong to specific apps totally independent of all processes making it possible for pure autonomous automation.

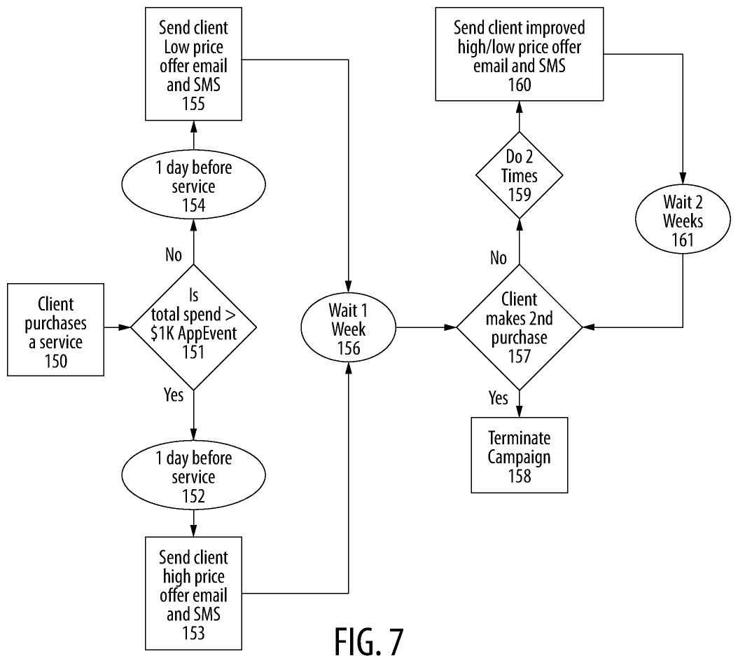

An example is illustrated in FIG. 7, one utility application provided by the context-aware computing platform 10 is an AutoPilot Marketing App and implement an Upsell Offer based upon the client's total spend. The automation is triggered by a client purchase a service event in Step 150.

The context-aware computing platform 10 determines whether the client's total spend is more than a predetermined value, such as $1000 in Step 151. In the event, that the purchase value is higher than the predetermined value, the context-aware application 10 will wait until 1 day before the service in Step 152. Then, the context-aware computing platform 10 follows the workflow of the OneAuto, and automatically provides the client with a high-priced offer in Step 153. If the client spends less than $1000, the client is provided with a low-priced offer following Step 154 and Step 155. Hence, the workflow is automatically determined by assessing the decision made by the client and other criteria, or by rules-based cognitive automation as shown in Steps 150 to 161.

In this example, when a client makes a purchase in Step 150, the context-aware computing platform 10 will determine in Step 151 if the purchase conditions meet any of the AppEvents. If the AppEvent Up-sell Offer conditions are met the client is placed in the AutoEngine campaign list.

Periodically, the AutoEngine checks the campaign list in Step 156. When the AutoEngine of the context-aware computing platform 10 found an upsell offer, it starts by checking if the AppEvent is met, such as the Client Total Spend is greater than $1000. If the AppEvent meets the criteria, the AppEngine of the context-aware computing platform 10 then checks the events related to the greater than $1000 if no it checks the events for the less than $1000 in Step 151. If any of the events are for that current day, it executes them; if not, it moves to the next item in the campaign list.

On the day before the booked service in Step 152 and Step 154, the AutoEngine checks the campaign list, it finds the Upsell offer has two events to run which are the high-priced offer email and high-priced offer SMS in Step 155. It uses the OneData algorithms to get the data required to dynamically create the email and SMS templates and then passes the template info to OneApp which then sends the email and SMS in Step 155.

The above process is repeated until all the Events are run in the upsell offer OR when the exit condition is met, the client purchases the high-priced offer.

The main difference with other systems and the integrated application of the present invention 10 is that the whole process above was built and run with a standard office like utility applications that are made possible with OneData, OneApp, and OneAuto, other systems would require numerous API's and other RPA like additions.

Modern computing system comprises a series of utility software. For example, Microsoft 365 is a massive office suite comprises a series of software applications—Words, Excel, PowerPoint, Publisher, Outlook, etc but these applications do not communicate with one another and create silos of customer data.

Some software applications are highly industry-specific. These software applications offer poorly customisation capabilities and rely heavily on other apps like Microsoft Office. There is a lack of inter-applications communications. Data needs to be entered separately for each app and be stored in different formats and locations. There is no automated external app. They create silos of data and are sometimes redundant and are bound to work a specific way and have limited differentiation.

Sale and CRM application is another example of an integrated software application which comprises a number of utility applications. Typically, the Sale and CRM application provides a web-based interface and runs via limited browser capabilities. It usually requires the purchase of numerous modules or utility applications which create silos of customer data, don't support a unified data model, don't maintain contextual data and don't have context-aware capabilities. This means they have limited automation across the modules due to limited inter-module API's, require complex and expensive automation tools that require automation consultants and engineers.

In an embodiment, there is provided an intelligent messaging system built on top of the integrated electronic system of the present invention implementing the OneData, OneApp, and OneAuto modules and AppFunctions library. The intelligent messaging system comprises, one or more intelligent message routers for intelligent message routing for routes messages to the most appropriate person, an intelligent categorisation module for automatically adding labels/tags to each message to be quickly identified; an intelligent parser that creates customer files; adding email information to the specific database fields in the OneDB, and automatically responds with dynamic contextual-data; an intelligent context-aware filing system for automatically filing of all sent, received and created emails, SMS, web forms, documents, pictures, quotes, invoices, etc, and an autonomous context-aware auto responder adapted to automatically respond to emails, faxes, SMS and even print letters.

The intelligent message router is a content-based router based on application-oriented networks. In one embodiment, the intelligent message router works at layer 7 of the OSI stack and adapted to examine the content of the message for routing. The intelligent message router is adapted to follow routing policies and make routing decisions based on different criteria of the content of the messages, including client name, the purpose of the message, the value of the purchase order, or the delivery date. In one embodiment, the intelligent message router comprises static buffers to handle the inter-process application. In another embodiment, dynamic inter-port buffer allocation and intra-port buffer allocation algorithm is implemented to improve the interprocess communication.

In one embodiment, the intelligent message router comprises a routing policy manager (RPM) adapted to determine the right message destination and routing requirements according to context analysis. In one embodiment, the RPM is adapted to generate self-aware and self-managed routing decisions to deal with the multidimensionality and a large amount of source, target, and message contextual data that come from uncertain sources. The RPM may use an artificial intelligence algorithm on the unified data model (OneData) to make the routing decision (OneAuto).

In one embodiment of the present integrated application, there is provided an integrated calendar application. In this integrated calendar application, the unified data model (OneData), unified application (OneApp), and an interprocess automation (OneAuto) are adapted to managed feature access with multiple calendar applications on one calendar interface. These features include: a single application to view, manage, and edit all company, location, resource, and user calendars and access their features. The integrated calendar application of the present invention is adapted to generate context-aware customer appointments automatically instead of manually creating appointments and automatically sending context-aware appointment responses, such as confirmations, with SMS, email, and printed letter, etc.

In one embodiment, the integrated calendar application of the context-aware computing platform 10 is adapted to synchronise data of proprietary calendars to and from any mobile or tablet device. Resources or Users have Calendars which have appointments which are connected to jobs/services that belong to an invoice that can be viewed in accounts. Appointments are customisable and can be categorised, colour coded, can have notes which are connected to a client file. They automatically send emails or SMS with booking details, reminders, and even invoices. By hovering a pointer over an item on the graphical user interface, the integrated application of the present invention will allow a user to view all relevant data from one graphical user interface.

In one embodiment of the present invention, the context-aware computing platform 10 is adapted to dynamically generate customised workflow with an AppEvent. When a message, letter, SMS, calendar appointment, or email is received by the integrated application of the present invention, it will automatically trigger an AppEvent which may then generate a customised workflow of tasks to tell the user what to do, when and how to do it. The tasks may comprise automated actions, such as sending out personalised emails, SMS, letters, notes, and even booking appointments, saving time, reducing redundant work, minimising errors, recording data on the calendars with meeting appointment automatically generated, and sending meeting requests and confirmations to the participants. In one embodiment, multiple workflows to manage each step of a process which generates a list of actions for each staff. In order to achieve this function, there is required the OneData, OneApp, and OneAuto such that the integrated application. The context-aware computing platform 10 may also provide an interface to monitor staff workloads, what has and hasn't been completed, when and at any moment of a day.

In one embodiment of the present invention, the context-aware computing platform 10 is adapted to use OneData, OneApp, and OneAuto to execute the cognitive marketing function. The OneData allows a user to access data from all AppFunctions such that the same data can be access through different utility applications. This can ensure the data is consistent with all utility applications.

The consistency of data allows the user to maximise the leads and promote lead nurturing of customers. It also automates repeat business with up-sell and cross-sell campaigns. The cognitive marketing function is also adapted to simplify and automate special offers that will reward customers with special offers and further increase repeat business. The cognitive marketing function allows the user to run different marketing campaigns based on the customer's personal information through the OneData and OneApp to promote business by using AppFunction to access OneData storing customer data from different utility applications.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. An electronic system comprising a single unified data module (OneData), a single unified application module (OneApp), and an interprocess automation module (OneAuto).

2. The electronic system of claim 1, wherein the OneData module comprises: a single logical managed storage to allow access of all application files and document (OneStore); a unified logical database for all application data, template, and integration (OneDB); and a single data format where a common data format is used for all files and document types (OneFormat).

3. The electronic system of claim 1, wherein the OneData module is adapted to perform context-based entity resolution to store and manage files and digitalised documents into a logical database by algorithms that maintain a Unified Context Data Model (UCDM), for preserving the virtual linking of all associated contexts and entities.

4. The electronic system of claim 3, wherein the Unified Context Data Model (UCDM) is adapted by using context entity resolution (CER) to identify different data context fields (nodes) and create unidirectional linked together and organized by entity references (links or pointers).

5. The electronic system of claim 3, wherein the Unified Context Data Model (UCDM) is both Multi-App for managing data of all Apps, and Multi-Dimensional for providing a context-graph mind map (CGMM) view of the inter-relationship between all the associated information architecture items.

6. The electronic system of claim 3, wherein the UCDM is adapted to deliver context-graph mind map (CGMM) for managing internally a large list of context graph information and the inter-relationship between associated context and entity items by algorithms.

7. The electronic system of claim 1, wherein the OneData module comprises a set of application interfaces adapted to access to each software application (app) data model to enable all apps to access data from other apps.

8. The electronic system of claim 1, wherein a single unified context-aware application (OneApp) comprising a set of functions (AppFunctions) and events (AppEvents) adapted to control and be controlled by other apps, processes, and the automation engine to form a plurality of utility software applications.

9. The electronic system of claim 8, wherein the AppEvents are adapted to enable independent processes to be triggered by application events which then could execute AppFunctions.

10. The electronic system of claim 7, wherein the AppFunction is a process adapted to be executed as an individual thread on an electronic device.

11. The electronic system of claim 1, wherein the OneAuto is adapted to provides four kinds of automations, comprising user driven automation (assisted), process driven automation (unassisted), system automation, and cognitive automation.

12. The electronic system of claim 11, wherein the user driven automation is a module comprising the user-driven automation AppFunctions, wherein the AppFunctions are triggered by a user input.

13. The electronic system of claim 11, wherein the process driven automation is a module comprises the process driven AppFunctions.

14. The electronic system of claim 11, wherein the system run automation (Autonomous) is a module comprising the independently AppFunctions runs by the system.

15. The electronic system of claim 11, wherein the decision driven (Cognitive) automation is a module comprising the independently executed rules-based decision making AppEvents.

16. The electronic system of claim 11, wherein user driven automation (Assisted), process driven automation (unassisted), system run automation (Autonomous), and decision driven automation (Cognitive) are all controlled by OneSystem automation scheduling subsystem to provide a comprehensive set of automation features for user and process automation for the OneApp module and OneData module.

17. The electronic system of claim 1, further comprising an intelligent messaging system implementing the OneData, OneApp, and OneAuto modules and AppFunctions library, wherein the intelligent messaging system comprises, one or more intelligent message routers for intelligent message routing for routes messages to the most appropriate person, an intelligent categorisation module for automatically adds labels/tags to each message to be quickly identified, an intelligent parser that creates customer files, adds email information to the specific database fields in the OneDB and automatically responds with dynamic data, an intelligent filing system for automatically filing of data, and a dynamic context-aware auto responder adapted to automatically respond to emails, faxes, SMS and even print letters.

18. The electronic system of claim 17 wherein the intelligent message router is a content-based router based on an application-oriented network adapted to examine the content of the message for routing.

19. The electronic system of claim 1, further comprising an integrated calendar application with the unified data model (OneData), unified application (OneApp), and interprocess automation (OneAuto) adapted to managed feature access with multiple calendar applications on one calendar interface.
